(19) United States
(12) Patent Application Publication
(10) Pub. No.: US 2009/0157484 A1
(43) Pub. Date: Jun. 18, 2009

(54) Method and system for directing a user from a content provider website to an advertiser's website

(76) Inventor: Joshua Marc Konowe, Reston, VA (US)

Correspondence Address: Hoffman, Wasson & Gitler, P.C., Suite 522, 2461 South Clark Street, Arlington, VA, 22202, US

(21) Appl. No.: 12/289,837

(22) Filed: Nov. 5, 2008

Related U.S. Application Data
(60) Provisional application No. 60/996,183, filed on Nov. 6, 2007.
(60) Provisional application No. 60/996,597, filed on Nov. 27, 2007.

(51) Int. Cl. G06Q 30/00; G06Q 10/00; G06F 17/00; G06F 15/16

(52) U.S. Cl. 705/10; 705/14; 715/207; 709/203

(57) ABSTRACT

A method of allowing a consumer to be hyperlinked from a content provider's website to an advertiser's website based upon the use of one or more keywords. The advertiser would associate the URL address, of one of the advertisers with one or more keywords provided on the content provider's website. Therefore, when a consumer would click on these keywords, they would be sent to the website designated by the advertiser.

### CROSS-REFERENCE TO RELATED APPLICATIONS

The present invention claims the priority of U.S. provisional patent application Ser. No. 60/996,183, filed Nov. 6, 2007, and U.S. provisional patent application Ser. No. 60/996,597, filed Nov. 27, 2007.

### FIELD OF THE PRESENT INVENTION

The present invention is directed to a method and system for controlling the hyperlinking from a content provider's website to particular advertiser's website based upon information provided by the particular advertisers.

### BACKGROUND OF THE INVENTION

There is no question that the Internet has become a most valuable tool both in the U.S. and in the rest of the world. This tool is used not only for entertainment by consumers but also as a means of research as well as obtaining information on a plethora of subjects. Various surveys have concluded that, for example, the use of print media to disseminate information is decreasing yearly and the Internet has taken its place. This is due to the fact that more and more individuals are utilizing the Internet as their main or only source of obtaining news. Additionally, individuals are using the Internet as a prime source of doing both scholarly research as well as to determine the answer to many every day questions or problems that they face. Therefore, since less and less individuals are using print media on a daily, weekly or monthly basis, the revenue streams for the traditional print media are rapidly diminishing. Rather, large portions of advertising revenue have been diverted to various online search engines such as, but not limited to Google, Yahoo! and AOL. Consequently, this would reduce the return for the traditional print media. Additionally, the various types of banner headlines as well as other intrusive advertising techniques would diminish the enjoyment of the average user on the Internet.

With respect to advertisers, which would include, but not limited to corporations, media companies and noted individuals, major web portals such as those previously listed would allow and encourage other competing advertisers to bid on the use of their trademark/brand names, thereby eroding brand equity and increasing costs to the trademark and brand name owners and advertisers. This would mean that there would be no transparency in a bidding process and there is a lack of highly-targeted traffic which would be directed to the advertisers own websites.

At the present time, content providers would include but not limited to various newspapers, magazines, radio and television program discussion forums, blogs, message boards, social networking sites, e-commerce businesses, instant messaging applications and product review sites. These types of content providers have, in the past several years, instituted their own websites which are frequented by consumers who previously used these various types of media, as well as new users. It is also noted that content providers could also include blogs and Internet only information sources.

Articles, stories and other contents generated by these content providers often focus on a well known subject. It would be common to highlight a word or words within the content and provide a link to another article or website which might prove interesting to the public. For instance, if CNN.COM posts a story regarding General Motors, it is common to highlight the term “General Motors” and use this term as a link to previous stories relating to General Motors that CNN.COM has already created. The reader of the original article, desiring more information on this highlighted term, would click on the term and would be hyperlinked to the related story. In this scenario, the user would never leave the CNN website.

Currently, content providers utilizing the Internet do rely on advertising to generate additional revenue. This advertising takes place in the form of banner ads. Despite the popularity of a particular Internet site, it is common for content providers to lose money and therefor, additional sources of revenue are sorely needed.

In addition to the aforementioned content providers, such as blogs and media outlets, various other entities such as e-commerce sites such as Ebay, Amazon and Buy.com which often sell products bearing trademarks or brand names would benefit from a scenario in which the public would be directed to their website to purchase various products or services. Software applications such as Word, Excel, PowerPoint or the like which will highlight a particular term when typed by the user as well as instant messaging applications such as AOL Messenger and social networking sites such as Facebook and MySpace might also benefit by the use of a consumer clicking a highlighted term to be directed to their own particular website.

### SUMMARY OF THE INVENTION

The present invention addresses the problems of the prior art by providing an in-text advertising platform designed to bolster the bottom line for online content providers and publishers as well as to deliver increased results to advertisers and enhance the online experience for readers. The system of the present invention would generate new revenue opportunities for online content providers and give advertisers more control of their trademark or non-trademark brands by enabling the content providers to optimize the content they create with revenue based metrics.

Additionally, the present invention would be to the benefit of advertisers, since the advertisers would directly pay the content providers for the traffic generated from the content that those providers have created. Therefore, advertisers would be able to optimize their advertising spending with more targeted programs.

The present invention would accomplish the aforementioned objects to the content provider as well as the advertisers by allowing the advertisers to specify the resultant website to which consumers are directed when they click on a highlighted term in an online article published or created by the content provider. The advertiser would then pay the content provider a specified amount each time a consumer clicks on an advertiser's particular highlighted trademark or brand name. Although the present invention has been described by allowing an advertiser to highlight the advertiser's brand name or trademark which is included in an article published by the content provider or which appears in any location on a website, this invention should not be so limited.

The present invention also contemplates a situation which advertisers would be able to highlight various generic keywords and phrases related to that company's business or industry. The present invention contemplates the use of appropriate filters to insure that the consumer is directed to the appropriate website. While this might be relatively easy to accomplish if a well known brand name such as General Motors, Ford or Chrysler would be highlighted, it is noted that the same trademark could be utilized by various unrelated companies. For example, the term Delta can refer to an airline, a power tool company or a faucet company. Consequently, the method and system according to the present invention would utilize the contents of a particular article which included the word Delta therein to direct the user or consumer to the correct website based upon the usage of the term Delta in the article. Therefore, if the article dealt with power tools, the user would be directed to a website of the owner of Delta's power tools trademark.

A single article by the content provider may have multiple links to a number of trademark terms, brand names or keywords of multiple advertisers. Therefore, the content provider would receive revenue each time any link is chosen by the consuming public. The content provider would have control over the links in the articles they generate by setting the potential number of links that would be in any article as well as the price for each click that the advertiser would pay when the user would activate the link and exit the content provider's website.

Additionally, the content provider would have the ability to block the consuming public from leaving the content provider's website if, by a consumer clicking a particular highlighted word or term, that consumer would be directed to a competitor of the content provider. This feature would allow a particular content provider to insure that the consumer would not be directed to a competitor's website.

Other objects and advantages of this invention will become apparent from the following description taken in connection with the accompanying drawings, wherein as set forth by way of illustration and example, an embodiment of the present invention.

### BRIEF DESCRIPTION OF THE DRAWINGS

FIG. 1 is a schematic drawing showing a system utilizing the method according to the present invention;

FIG. 2 is a drawing showing both a content provider's website and a portion of an advertiser's website;

FIG. 3 is a flow diagram showing the method in which a publisher registers according to the present invention;

FIG. 4 is a flow diagram showing the manner in which an advertiser would register according to the present invention; and

FIG. 5 is a diagram showing a screen that at advertiser would use during the registration process.

### DETAILED DESCRIPTION OF THE PRESENT INVENTION

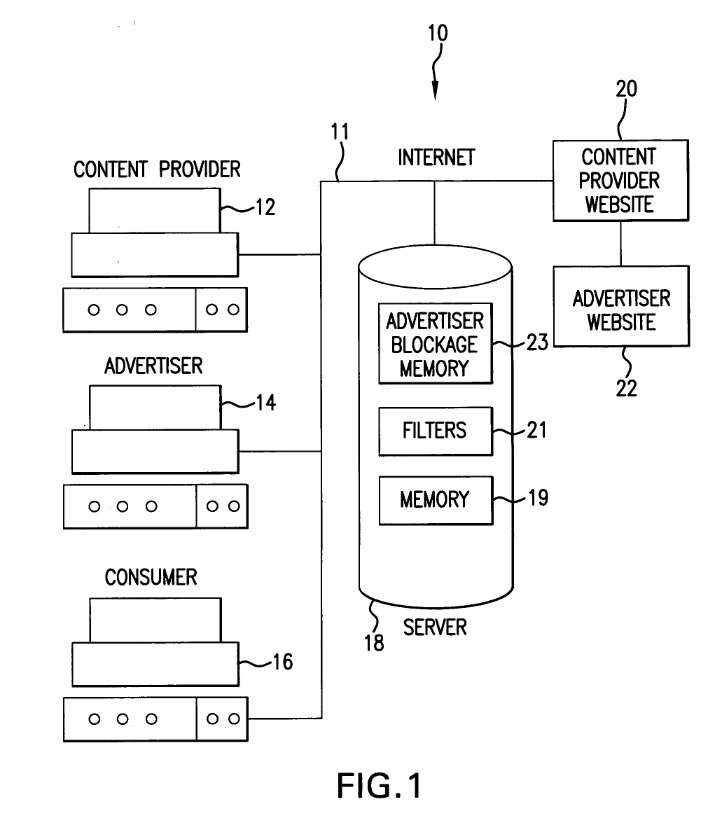

The present invention is directed to a method for providing a hyperlink between material provided on a content provider's website and a website chosen by an advertiser. A system 10 for implementing this method is illustrated with respect to FIG. 1. Various publishers 12, advertisers 14 and consumers 16 are linked by the Internet to a server 18 which would act to manage the entire system. In practice, the consumer or user 16 would, through the use of the Internet 11, would view a content provider's website 20. This website would contain an article or other material containing one or more highlighted words or phrases. Once the user or consumer clicks on one of the highlighted words or phrases, the consumer through the use of the server 18 would be directed to a particular advertiser's website 22. This is due to the fact that during a registration process as will be subsequently explained, the advertiser 14 would designate one or more keywords and would provide the server having a memory 19 with an URL address associated with each of the keywords or phrases. Once the consumer 16 clicks on a particular word or phrase, it would be then directed to the specific URL address designated by the advertiser 14 and this website 22 would be projected onto the consumer's display screen.

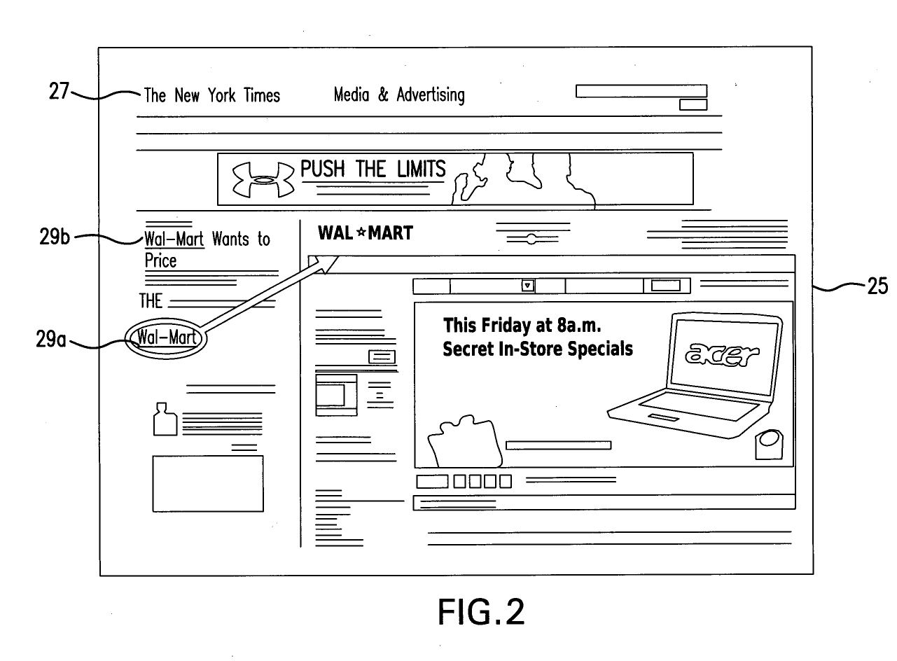

FIG. 2 illustrates a particular advertiser's website 25 as well as a content provider's website 27. For purposes of description, the advertiser's website 25 is for Walmart and the content provider's website 27 is the New York Times. One or more keywords in the content provider's website 27 would be highlighted in potentially, several variations. For example, it is noted that FIG. 2 highlights the particular keywords or phrases by various types of underlinings. Reference numeral 29a shows the term Walmart underlined once and reference numeral 29b underlines a second recitation of the term Walmart twice. Although generally, these variations of the underlinings would be for different keywords or phrases, for purposes of illustration, website 27 has underlined the same word with two variations. For example, underlining the word Walmart 29a with color lines such as red or blue would generally indicate that the user, when clicking on this keyword, would be directed to the Walmart site 25 as shown in FIG. 2. However, if a term is underlined with double lines such as green at 29b, the user would be directed to another website or another portion of the Walmart website which, for example, would allow the consumer to generate a coupon for the purchase of various products or services.

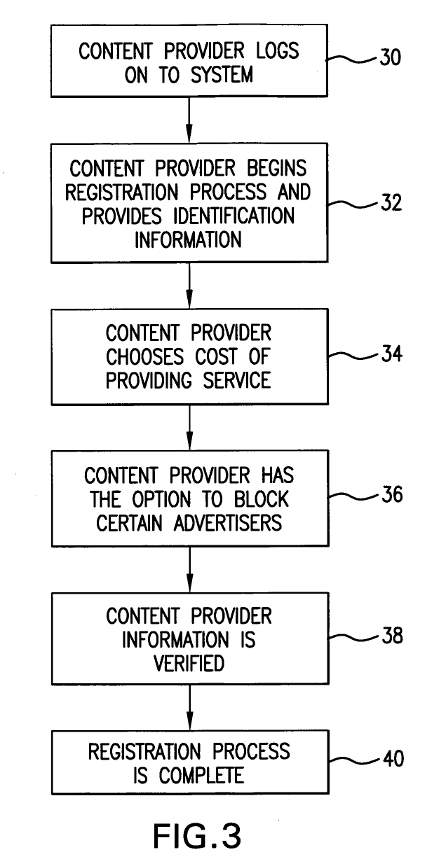

FIG. 3 illustrates a process in which a content provider would register to participate in the method of the present invention. Initially, the content provider would log on to the system at 30 and provide the operator of the system with information relating to the content provider, such as the personal name of an individual representing the content provider, the name of the content provider and various additional identification information such as a phone number and address at 32.

At this point, the publisher is given the opportunity to choose the cost that an advertiser would pay to the system every time a consumer clicks on a keyword included in the content in an article appearing on the content provider's website or in any location in the content provider's website at 34. The content provider can choose to utilize a default amount or can specify the exact “cost per click” (CPC) that the system would receive. Any time during the content provider's participation in this program, the CPC can be changed by an authorized member of the content provider's organization.

The content provider would also have the opportunity to prevent any competing content provider from directing the consumer from that content provider's website to the website of a competing content provider which would be in the form of blocking a particular advertiser at 36. This is accomplished by specifically identifying a particular advertiser or keyword that would be prevented from having a consumer hyperlinked from the website of the content provider to the website of an advertiser. Information relating to the blocked advertiser would be transmitted to the server 18 and provided within an advertising blockage memory 23. Software would be provided at the server 18 for projecting on to the content provider's screen during the registration process indicating the exact names of the advertisers currently participating in the program. At this point, the content provider would then designate that one or more advertisers be blocked. Additionally, the system could operate by allowing a content provider to designate an advertiser which, at the present time, is not participating in the program to be blocked if that particular advertiser subsequently joins the program. It is important to note that a particular content provider could only block a particular advertiser from hyperlinking a consumer from the content provider's website to the blocked advertiser's website but would not be able to entirely block that advertiser's participation in the general program.

During the registration process, the content provider would be provided with a relatively simple code to allow the content provider to participate in the described program. This code is placed at the end of the “body” tag on any present pages or subsequent pages of the website which the content provider wishes to use.

Once the registration process is complete, the information provided by the content provider would be verified at 38 by a system's operator to insure that the organization that has registered is a legitimate content provider and that the information is correct. Content providers can include but are not limited to online contact providers, discussion forums, blogs, message boards, social networking sites, e-commerce sites that sell trademark and brand name products, instant messaging applications as well as product review sites.

Once the registration process is complete at 40, the content provider will immediately become a participant of the program according to the present invention. The content provider would be provided with a percentage of the revenue that has been generated based upon the designated CPC and the number of clicks. The content provider can at any time during its participation in the program have a report generated which would indicate any and all of the advertisers which were directed to an advertiser's website based upon a consumer clicking on one of the keywords on the content provider's website as well as the click count and the total amount generated per advertiser as well as total amount of all of the advertisers.

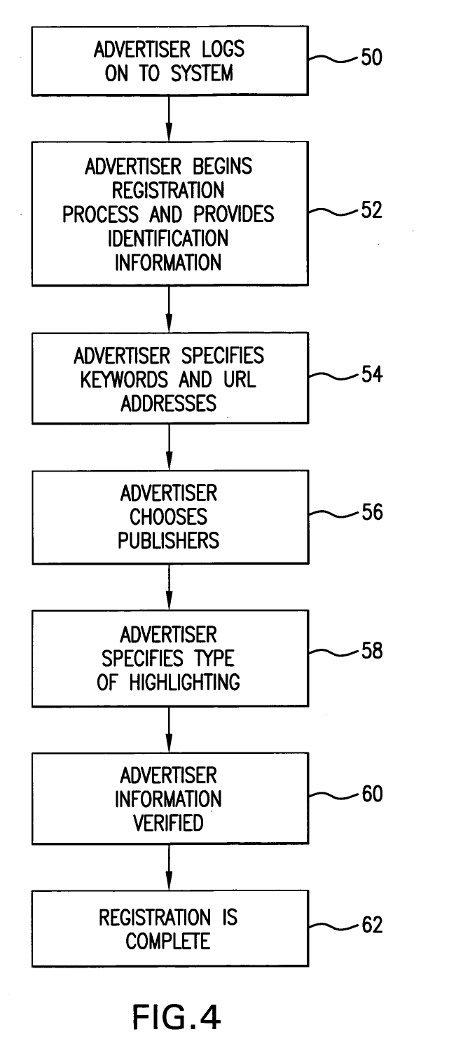

The manner in which an advertiser would become a participant of the system is illustrated with respect to FIG. 4. As shown therein, an advertiser would log onto the system at 50 to begin the registration process at 52 by providing the system with various account information relating to a particular advertiser, but not limited to the advertiser's name, address and email address. The advertiser would then be asked to fund their account in various manners such as but not limited to the use of national credit cards and/or the PayPal system.

At this point, the advertiser is prompted to enter a keyword into the system as well as a URL address for each of the keywords at 54. The advertiser would also be asked to specify the manner in which the keyword should be highlighted, such as using a double red and blue underline with either the use of a single line such as a green underline to designate that clicking on the keyword would link the user with the particular designated URL address or allowing the use of a double underlined highlighting, such as using a double red and blue underline which would link the consumer with, for example, a particular coupon to be used for the purchase of a product or service as previously described at 58. Once all this information is entered for a particular keyword, the advertiser would then have the opportunity to enter more keywords and the appropriate URL addresses for each of the keywords at 54.

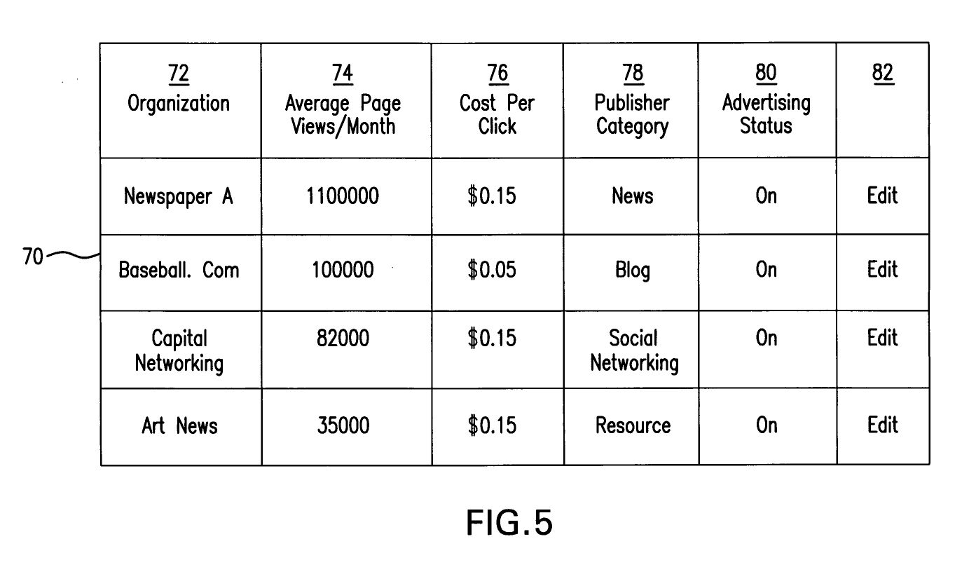

The advertiser at 56 would be provided with a screen as shown in FIG. 5 listing the current publishers which are participants to this system. The screen 70 would include column 72 listing each of the content providers. A column 74 would indicate the average number of views for each of the content providers and column 76 would indicate the CPC for the respective content providers. A column 78 is provided which would indicate the type of content provider listed in column 72 such as a news provider, a blog, a social network, a research or the like. Each advertiser then would review the information shown in FIG. 5 and would have the opportunity to choose the content provider's with which each of the advertisers would like to participate. This is accomplished by clicking the “edit” box in column 82 for each of the content providers.

During the registration process at 60, the system operator would verify the information provided by each of the advertisers to insure that the information provided is accurate and legitimate. At this point, once this information is verified the registration process for each advertiser is complete at 62.

Once the registration process is complete for a particular advertiser, the keywords entered by the advertiser for each of the content providers designated by that particular advertiser would automatically be highlighted in the appropriate locations in the content providers website. Additionally, the URL addresses to which a consumer would be directed upon clicking a particular keyword would also be transmitted to the memory 19 of the server 18. Furthermore, as previously indicated, the server 18 would be provided with appropriate filters 24 for determining the correct website to which the consumer would be directed based upon the contents of the article on the website.

Once consumers utilize their computer 16 to access a content provider's website 20 through the use of the Internet 11, any highlighted keyword that the consumer would click on would generate a communication between the website 20 and the server 18 which would provide the user's computer 16 with the correct URL address also provided in the memory of the server 18, thereby creating a link between the consumer's computer 16 and the advertiser's website 22. This communication between the content provider's website 20 and the server 18 would allow the memory 19 to properly credit the content provider's account based upon the specific CPC for that content provider as well as to debit the advertiser's account. Reports would be periodically generated indicating the number of CPCs for each of the account providers as well as each of the advertisers. After a period of time, each of the content providers would be sent their payment.

The foregoing is considered illustrative only of the principles of the present invention. Furthermore, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of establishing a link between a content provider's website and an advertiser's website, comprising the steps of:
establishing a first registry of content providers and their respective website or websites;
establishing a second registry of advertisers and their respective website or websites;
prompting each of said advertisers to choose at least one keyword or phrase and a designated Internet address associated with said keyword or phrase;
prompting each of said advertisers to choose at least one of said content providers listed in said first registry;
highlighting the appearance of each of said keyword or phrase provided within each of the websites of said content providers listed on said first registry chosen by each of said advertisers listed on said second registry;
a consumer clicking on one of said keyword or phrase highlighted on one of the websites of one of said content providers listed on said first registry; and
hyperlinking the consumer from the website of a content provider listed on said first registry to said designated Internet address of an advertiser listed on said second registry associated with the keyword or phrase clicked by the consumer in said previous step.

2. The method in accordance with claim 1, further including the step of each of said content provider listed on said first registry choosing a remuneration level to be received when the consumer clicks on one of said keyword or phrase highlighted on at least one of said content provider's website.

3. The method in accordance with claim 2, wherein each of said advertisers would pay said remuneration level when the consumer clicks on one of said keyword or phrase highlighted on said content provider's website and the consumer is directed to said designated Internet address.

4. The method in accordance with claim 1, further including the step of preventing a keyword or phrase of one of said advertisers listed on said second registry from being highlighted one on the website or website of one of said content providers listed on said first registry.

5. The method in accordance with claim 4, wherein said preventing step is initiated by one of said content providers listed on said first registry.

6. The method in accordance with claim 1, further including the step of providing a server at a remote location, said server including a memory storing said first and second registries, said keywords and phrases as well as designated Internet addresses.

7. The method in accordance with claim 4, further including the step of providing a server at a remote location, said server including a memory storing said keywords or phrases of all of the advertisers blocked by one or more of said content providers.

8. The method in accordance with claim 1, further including the step of checking the legitimacy of the content providers in said first registry and the advertisers in said second registry.

9. A system of establishing a link between a content provider's website or websites and an advertiser's website over the Internet, comprising:
a server provided with a memory, the server in communication over the Internet with a plurality of websites, said memory containing a first registry of content providers and Internet addresses associated with each of said content providers and a second registry of advertisers including at least one keyword or phrase and a designated Internet address associated with each keyword or phrase;
a mechanism for highlighting the keywords or phrases included in said second registry provided on websites of said content providers; and
a means for transferring a consumer from one of said central provider's websites to said designated Internet address when the consumer clicks on a highlighted keyword or phrase included on one of said content provider's websites.

10. The system in accordance with claim 9, wherein said first registry includes a remuneration level associated with each of said content providers.

11. The system in accordance with claim 10, wherein said memory updates a first account associated with each of said contact providers when the consumer clicks the keyword or phrase included in a particular content provider's website.

12. A system in accordance with claim 11, wherein said memory debits a second account associated with each of said advertisers when the consumer clicks on a keyword or phrase included in a particular content provider's website.

13. The system in accordance with claim 9, wherein said memory includes a list of advertisers whose keyword or phrase would not be highlighted on the website of a particular content provider.
